(19) United States
(12) Patent Application Publication
(10) Pub. No.: US 2007/0229394 A1
(43) Pub. Date: Oct. 4, 2007

(54) Headup display apparatus

(75) Inventors: Toshiki Ishikawa, Ichinomiya-city (JP); Hiroshi Andoh, Nagoya-city (JP); Takayuki Fujikawa, Nagoya-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/654,517

(22) Filed: Jan. 18, 2007

(30) Foreign Application Priority Data
Mar. 31, 2006 (JP) 2006-099465

(51) Int. Cl. G09G 5/00

(52) U.S. Cl. 345/7

(57) ABSTRACT

A display apparatus for use in a vehicle includes an irradiation source for irradiating a light of an image, a redirection component for redirecting the light of the image, an optical component for magnifying the image that enters therein, and a reflection component for reflecting the light of the image for an occupant of the vehicle. The redirection component is disposed at an angle to a light axis of the light of the image irradiated by the irradiation source in a light path between the irradiation source and the optical component, and the redirection component corrects a distortion of the virtual image being perceptible for the occupant of the vehicle by at least one of the optical component and the reflection component.

### CROSS REFERENCE TO RELATED APPLICATION

This application is based on and claims the benefit of priority of Japanese Patent Application No. 2006-99465 filed on Mar. 31, 2006, the disclosure of which is incorporated herein by reference.

### FIELD OF THE INVENTION

The present invention generally relates to a headup display apparatus in a vehicle.

### BACKGROUND OF THE INVENTION

In recent years, a headup display apparatus that projects a display image from a position in an inside of an instrument panel toward a surface of a windshield for reflectively providing for a driver of an automotive vehicle the display image as a virtual image is known to public.

The headup display apparatus basically provides supplemental information or the like required for driving operation by superposing the information on a front view of the vehicle, thereby preventing driver's eye from looking away from a front direction for information recognition. In this case, the virtual image serves better for the driver's eye in a greater distance, because the greater distance lessens the eye focus control efforts on the driver's side.

A reflection point of the display image on a final reflector on the windshield and a display device such as a liquid crystal display or the like define a projection distance of the virtual image. The projection distance of a predetermined value must be provided for suitably displaying the virtual image on the windshield. However, it is difficult for a space in the instrument panel to provide a required distance as a straight path. Therefore, the required distance from the windshield is earned by using optical components such as a lens, a magnifying glass or the like that provides equivalent condition of the required distance virtually in the following manner. That is, as shown in FIG. 17, a distance of the virtual image b is calculated by using a projection distance a from the optical component for magnifying the image to the display device, i.e., a lens, and a focal point f of the lens in Equation 1.

1/a−1/b=1/f [Equation 1]

In this case, when the value of f becomes smaller for the compactness of a case of the display device in the headup display apparatus, the distortion of the virtual image exceeds a threshold of acceptable level of distortion for comfortable recognition of the virtual image. Therefore, the display device and the optical component for magnifying are preferably positioned as far away as possible from each other in a limited space for decreasing a required magnification rate of the optical component in terms of the distortion of the virtual image to be maintained at a minimum level and for providing clarity of recognition of the virtual image.

For example, Japanese patent document JP-A-H04-247489 discloses a technique that uses an aspherical convex lens in a magnifying optical system having a relatively great focal distance f that maintains a curved image on a projection surface in a non-distinguishable level for suppressing the distortion of the virtual image. In this case, an optical path from the display device to the aspherical lens is folded by plural plane mirrors to be included in the limited space for the compactness of the case of the display device.

However, the magnification rate of the display image on the windshield according to the disclosure in the above patent document is not sufficient due to the limitation on the magnification rate that is bound by the distortion of the virtual image to be maintained in the non-distinguishable level. Further, when the optical path is prolonged for magnifying the display image to a greater extent without distortion, the size of the case of the display device is increased in return. In other words, by a conventional technique disclosed in the above disclosure, the display device of the headup display apparatus being disposed in a small case was not capable of expanding the display image to a sufficient magnification size without distortion.

### SUMMARY OF THE INVENTION

In view of the above-described and other problems, the present disclosure provides a headup display apparatus that provides a sufficiently magnified virtual image (a display image) having a distortion in an appropriate level for a driver of a vehicle without increasing a volume of the apparatus.

In one aspect of the present disclosure, the display apparatus for use in a vehicle includes an irradiation source for irradiating a light of an image, a redirection component for redirecting the light of the image, an optical component for permeably magnifying the image in a course of permeation therethrough when the light of the image redirected by the redirection component enters therein, and a reflection component for permeably reflecting the light of the image for visual perception of the light of the image as a virtual image by an occupant of the vehicle when the light of the image magnified by the optical component enters therein. The redirection component is disposed at an angle to a light axis of the light of the image irradiated by the irradiation source in a light path between the irradiation source and the optical component, and the redirection component corrects a distortion of the virtual image in the visual perception by the occupant of the vehicle by at least one of the optical component and the reflection component.

The redirection component interposed between the irradiation source and the optical component allows the light of the image to be projected on a reflection surface of the redirection component before the light of the image spread out. That is, the size of the redirection component and the size of the headup display apparatus is reduced by redirecting the light of the image before spreading out.

Further, the distortion of the image reflected by the reflection component due to the optical component and the reflection component is compensated by the redirection component in a pre-processing manner before the image passes through the reflection component and the optical component. Therefore, the occupant of the vehicle is provided with the image that is not substantially distorted. In addition, the magnification rate by the optical component is increased because of the compensation of the distortion in the pre-processing manner by the redirection component before magnification. That is, the image from the irradiation source can be magnified with an accompanying distortion maintained in suppression.

### BRIEF DESCRIPTION OF THE DRAWINGS

Other objects, features and advantages of the present invention will become more apparent from the following detailed description made with reference to the accompanying drawings, in which:

FIG. 1 shows an illustration of a headup display apparatus in a first embodiment of the present disclosure;

FIG. 2 shows a side view of an optical system in the headup display apparatus in the first embodiment;

FIG. 3 shows a side view of a light path in a case of the headup display apparatus in the first embodiment;

FIG. 4 shows a transparent perspective view of an adjustable (free-form) surface mirror in the first embodiment;

FIGS. 5A and 5B show illustrations of a side view of the optical system having the free-form surface mirror and a Fresnel lens in the first embodiment;

FIG. 6 shows a side view of the light path in the case of the headup display apparatus in a modification of the first embodiment;

FIG. 7 shows a side view of the light path in the case of the headup display apparatus in another modification of the first embodiment;

FIG. 8 shows a side view of the optical system in the headup display apparatus in a second embodiment of the present disclosure;

FIG. 9 shows a side view of the optical system in the headup display apparatus in a modification of the second embodiment;

FIG. 10 shows a perspective view of the Fresnel lens in another modification of the second embodiment;

FIG. 11 shows a side view of the optical system in the headup display apparatus in another modification of the second embodiment;

FIG. 12 shows a perspective view of the Fresnel lens in yet another modification of the second embodiment;

FIG. 13 shows a side view of the optical system in the headup display apparatus in yet another modification of the second embodiment;

FIGS. 14A and 14B show illustrations of an optical component in still yet another modification in the second embodiment;

FIG. 15 shows a side view of the optical system in the headup display apparatus in still yet another modification of the second embodiment;

FIGS. 16A and 16B show illustrations of the optical component in still yet another modification in the second embodiment; and

FIG. 17 shows an illustration of a relationship between the optical component and a virtual image in a general display device.

### DETAILED DESCRIPTION OF THE PREFERRED EMBODIMENTS

Embodiments of the present invention are described with reference to the drawings. Like parts have like numbers in each of the embodiments.

### First Embodiment

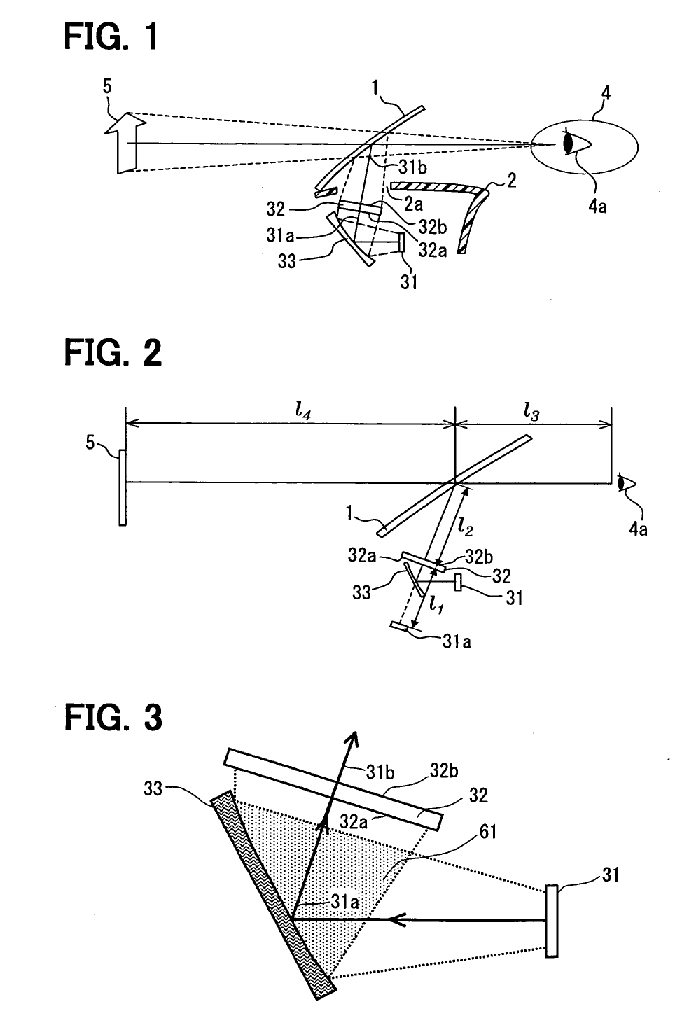

FIG. 1 shows an illustration of a headup display apparatus in a first embodiment of the present disclosure. FIG. 2 shows a side view of an optical system in the headup display apparatus in the first embodiment. FIG. 3 shows a side view of a light path in a case of the headup display apparatus in the first embodiment.

The headup display apparatus includes a display device 31, a Fresnel lens 32, a free-form mirror 33 in its optical system. The display device 31 is a source of irradiation of a display image. The Fresnel lens 32 is used for magnification of the display image on the display device. The components in the optical system of the headup display apparatus are formed in an inside of an instrument panel 2 under a windshield 1 on a front side of a vehicle. The Fresnel lens 32 is disposed in a proximity of an opening 2a of the instrument panel 2 with its light axis perpendicularly aligned to a light axis of a reflected image 31a (so called ‘coaxially aligned’). The Fresnel lens 32 is formed with a transparent material having plural circular grooves centered around the light axis of the reflected image 31a on both surfaces.

The free-form mirror 33 is disposed between the display device 31 and the Fresnel lens 32 with its axis diagonally aligned with the light axis of the display image. The angle of the axis of the Fresnel lens 32 to the light axis of the display image is, for example, in a range between 10 degrees and 45 degrees. In the present disclosure, the ‘light axis’ is a light path positioned at a ‘center of gravity’ in a bundle of plural light rays for displaying the display image.

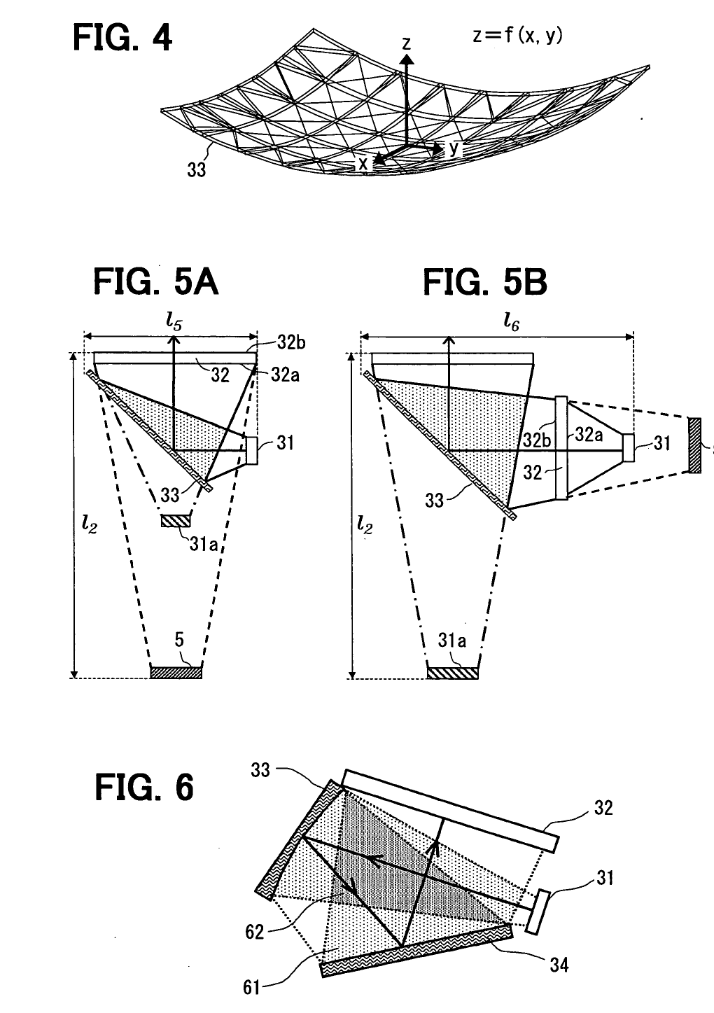

Further, a position of an eye of the driver is illustrated as an eyepoint 4, and the eye itself is designated as an eye 4a in FIG. 4. In addition, an image projected on the eye 4a of the driver is designated as a virtual presentation image 5.

The optical system illustrated in FIG. 2 is described in the following. The distance between the reflected image 31a reflected by the free-form mirror 33 and the Fresnel lens 32 is designated as a distance I₁, and the distance between a point in the Fresnel lens 32 that allows the light axis to pass through and a point in the windshield 1 that allows the light axis to pass through is designated as a distance I₂. Further, the distance between a point in the windshield 1 that allows the light axis to pass through is and the eye 4a of the driver is designated as a distance I₃, and the distance between a point in the windshield 1 that allows the light axis to pass through and the virtual presentation image 5 is designated as a distance I₄. In this case, when, for example, the distance I₁ is assumed to be 150 mm, the distance I₂ is assumed to be 200 mm, the distance I₃ is assumed to be 600 mm, and the distance I₄ is assumed to be 1400 mm, the magnification rate of the optical system in the headup display apparatus is required to have the value of 8. That is, the value of 8 is derived in the following equation.

I₁−I₂/I₁=1200/150=8 [Equation 2]

Distribution of the magnification rate in the optical system is determined in the following manner. That is, the distance between the display device 31 and the Fresnel lens 32 in the headup display apparatus is restricted by an installation space in the instrument panel 2 of the vehicle, thereby making most of a whole magnification rate (e.g., 7.5 out of the value of 8) of the optical system to be assigned to the Fresnel lens 32. In other words, the focal distance of the Fresnel lens 32 is determined in this manner. In addition, a shape of the free-form mirror 33 is determined to compensate the distortion of the image by the windshield 1 and the Fresnel lens 32 as well as the magnification rate of the Fresnel lens 32.

The free-form mirror 33 is described further in detail with reference to the illustration in FIG. 4.

The “free-form mirror’ in a general definition is a mirror that has a thickness z in a light axis direction defined by a polynomial expression of (x, y) coordinates on a perpendicular plane relative to the light axis. The free-form mirror 33 in the present embodiment has an asymmetrical shape in terms of rotation around the light axis (z axis). Further, the image on the display device 31 is, in general, distorted in the course of magnification by the Fresnel lens 32 and permeation therethrough. The distortion of the image is also caused by the windshield 1 in the course of reflection and the permeation therethrough. Therefore, the reflected image 31a is pre-distorted by the free-form mirror 33 before the distortion by the Fresnel lens 32 and the windshield 1. In other words, a content of the display image such as a rectangle can be displayed and recognized by the driver in an expected shape under a controlled pre-distortion in a compensating manner to the display image caused by the free-form mirror 33 in the course of reflection when the display image is recognized by the driver as the virtual presentation image 5 after the distortion by the Fresnel lens 32 and the windshield 1 in succession to the irradiation by the display device 31. That is, the free-form mirror 33 controls the controlled pre-distortion of the reflected image 31a for compensating the distortion by the Fresnel lens 32 and the windshield 1 so that a final image provided for the driver is presented in a ‘normalized’ shape.

As illustrated in FIG. 3, the light axis of the image (i.e., the reflected image 31a) reflected by the free-form mirror 33 enters perpendicularly into an incident side surface 32a of the Fresnel lens 32. In the course of entrance into the incident side surface 32a, the bundle of the light rays of the reflected image 31a and the bundle of the light rays of the display image irradiated by the display device 31 intersect with each other in a space 61. However, the traveling directions of the respective light rays are different, thereby not causing the interference. The light axis of the reflected image 31a entering the incident side surface 32a of the Fresnel lens 32 is outputted from an output side surface 32b of the Fresnel lens 32 for magnifying the reflected image 31a that is derived from the display image. The final image after magnification of the reflected image 31a is projected as an expanded image 31b on the windshield 1 as shown in FIG. 1.

A portion of the light rays of the expanded image 31b projected on the windshield 1 is reflected toward the eye 4a of the driver by the windshield 1. In this manner, the driver can recognize the virtual presentation image 5.

The advantages of the first embodiment of the present disclosure is described in the following.

First of all, the virtual presentation image 5 provided for the driver is in a substantially normalized form after compensation caused by the distortion by the free-form mirror 33 even when the image is distorted by the Fresnel lens 32 and the windshield 1.

Further, the distortion of the image in the course of magnification by the Fresnel lens 32 is suitably compensated by the free-form mirror 33, thereby allowing the magnification of the image to have a greater flexibility. Therefore, the image provided for the driver has a sufficient size for the ease of recognition.

Furthermore, the optical system in FIG. 5A that reflects the display image by the free-form mirror 33 before the image is magnified by the Fresnel lens 32 has a smaller width I₅ than the optical system in FIG. 5B that reflects the display image by the free-form mirror 33 after the image is magnified by the Fresnel lens 32 having the width I₆ when the distance toward the virtual presentation image 5 is set to I₂ in both cases. That is, the compactness of the apparatus is improved by reflecting the smaller image before magnification.

Furthermore, the curvature of the free-form mirror 33 is maintained to be minimum by assigning most of the magnification function to the Fresnel lens 32. In this manner, the distortion of the reflected image 31a is suppressed in otherwise difficult situation caused by de-centering of the light axis of the free-form mirror 33.

Furthermore, the image is effectively magnified by allocating a sufficient distance between the Fresnel lens 32 and the display device 31 in the apparatus having a limited volume due to an appropriate arrangement of the Fresnel lens 32 and a shortened light path for image magnification.

In addition, the distortion of the image compensated by the free-form mirror 33 includes a shape distortion, a field curvature, and astigmatism.

Modifications for the first embodiment are described in the following.

The light path of the display image is folded by a single piece of the free-form mirror 33 in the present embodiment. However, the light path may be folded a plane mirror 34 in addition to the free-form mirror 33 as shown in FIG. 6. As a result, the light path may be threefold in a space of the apparatus for improved compactness of the apparatus through a flexible arrangement of the display device 31, the Fresnel lens 32 and the free-form mirror 33. In addition, two or more pieces of the plane mirror may be used in the apparatus as shown in FIG. 6.

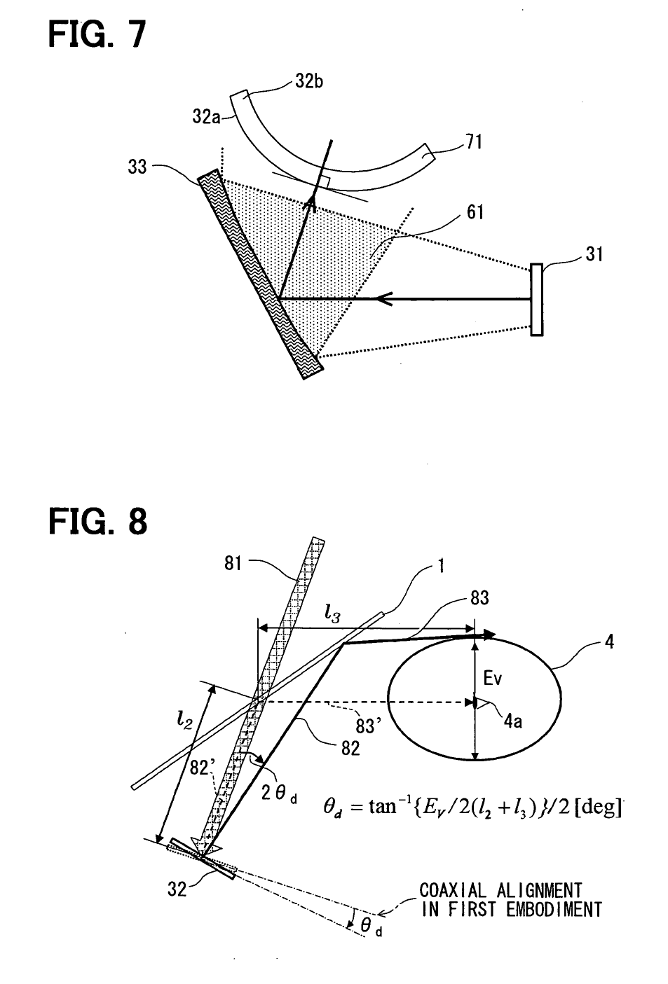

The grooved Fresnel lens 32 on a transparent material having a board shape in the present embodiment may be replaced with a spherical Fresnel lens 71 that has grooves on both surfaces of the hemisphere with a hollow space contained therein as shown in FIG. 7. The light axis of the reflected image 31a perpendicularly enters the spherical surface of the Fresnel lens 71 for implementing the advantages described above.

### Second Embodiment

A second embodiment on the present disclosure is described with reference to FIG. 8. The difference between the first and the second embodiment exists in that the reflected image 31a enters the incident side surface of the Fresnel lens 32 obliquely, and the expanded image 31b is output from the Fresnel lens 32 obliquely. The rest of the second disclosure has the same structure and thus has the same numerals for omitting the description in this section.

The Fresnel lens 32 shown with a broken line in FIG. 8 is the Fresnel lens 32 coaxially aligned with the reflected image 31a in the first embodiment. A light ray 81 from an external light source is reflected by the output side surface 32b of the Fresnel lens 32, and then is reflected again by the windshield 1. A reflected light 82a′ reflected by the output side surface 32b proceeds substantially parallel relative to the expanded image 31b. Further, reflected light 83′ reflected by the windshield 1 proceeds substantially parallel relative to the expanded image 31b reflected by the windshield 1. In this manner, the virtual presentation image 5 of the light ray 81 from the external light source is visually recognized by the driver, thereby dazzling the eyes of the driver.

Therefore, in the second embodiment, the light axis of the Fresnel lens 32 is tilted. That is, the tilt angle of the Fresnel lens 32 from the plane that is perpendicular to the light axis of the reflected image 31a is defined by an equation 3 in the following.

θ_{d}=tan⁻¹{E_{V}/2(I₂+I₃)}/2[deg] [Equation 3]

The light axis of the Fresnel lens 32 in the second embodiment is tilted from the coaxial alignment by the above described angle. In this case, the parameter E_{V} is a height of an eye range defined in JIS (Japanese Industrial Standard) specification. The Fresnel lens 32 tilted by the angle of θ_{d} or more reflects the light ray 81 from the external light source such as a sun light as the reflected light 82a by the reflection on the output side surface 32b, and the reflected light 82a is reflected again by the windshield 1 as the reflected light 83 to be projected toward an outside of the eye range 4 of the driver as shown in FIG. 7.

In this manner, the reflected light 83 is not superposed on the virtual presentation image 5 for visual recognition. The tilt angle θ_{d} of the Fresnel lens 32 is determined in a range that maintains the distortion of the virtual presentation image 5 to be within a certain degree. For example, the tilt angle θ_{d} of the Fresnel lens 32 may be between the value of 0 degree and 10 degrees.

The distortion caused by the Fresnel lens 32 that does not have the coaxial alignment is compensated by adjusting a reflection surface of the free-form mirror 33. That is, the free-form mirror 33 can compensate the distortion caused by both of the windshield 1 and the Fresnel lens 32 at the same time. In this manner, the virtual presentation image 5 of, for example, a rectangular shape is provided for the driver of the vehicle in a normalized form in the same manner as the first embodiment.

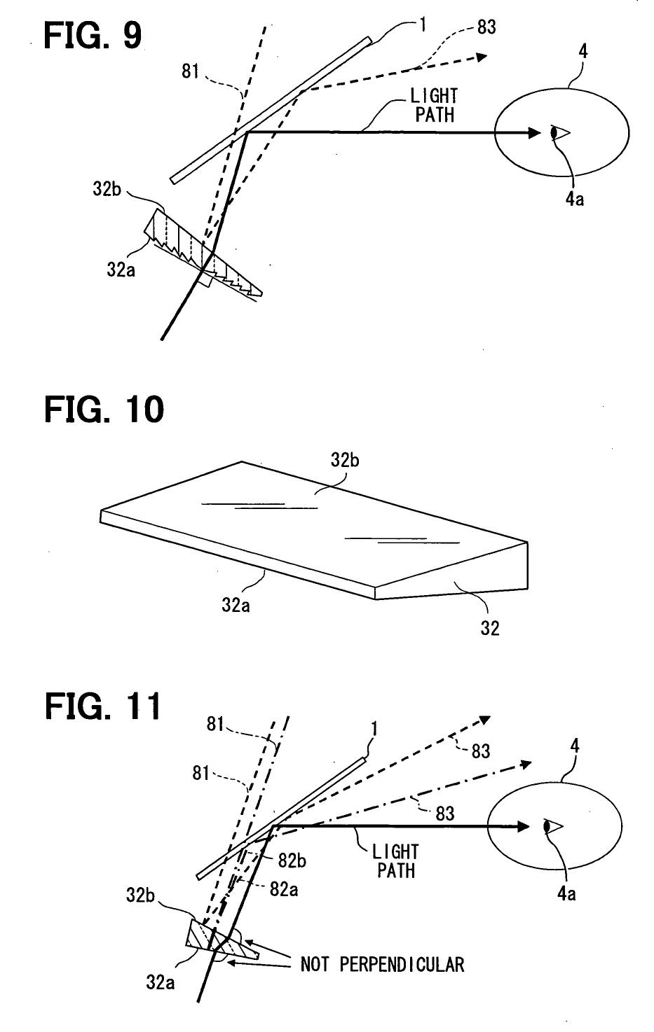

Modifications of the second embodiment are described in the following description. In one case, the modification of the Fresnel lens 32 may have a shape as shown in FIG. 9. That is, the Fresnel lens 32 may have the incident side surface 33a having the Fresnel pattern formed thereon to be perpendicularly aligned with the light axis of the reflected image 31a, and may have the output side surface 32b to be tilted relative to the light axis of the expanded image 31b. In this manner, as shown in FIG. 9, the reflected light 82a from the external light source reflected by the output side surface 32a is directed toward an outside of the eye range 4.

Another modification of the second embodiment is described with reference to FIG. 10. The Fresnel lens 32 in FIG. 10 has a wedge shape that positions the incident side surface 32a and the output side surface 32b in a non-parallel arrangement. The Fresnel lens 32 in the present modification has the light axis of the expanded image 31b on the incident side surface 32a tilted relative to the light axis of the expanded image 31b on the output side surface 32b. In this manner, as shown in FIG. 11, the reflected light 82a from the external light source reflected by the output side surface 32a and the reflected light 82b on a reverse side of the incident side surface 32a are respectively directed toward a different direction away from the virtual presentation image 5.

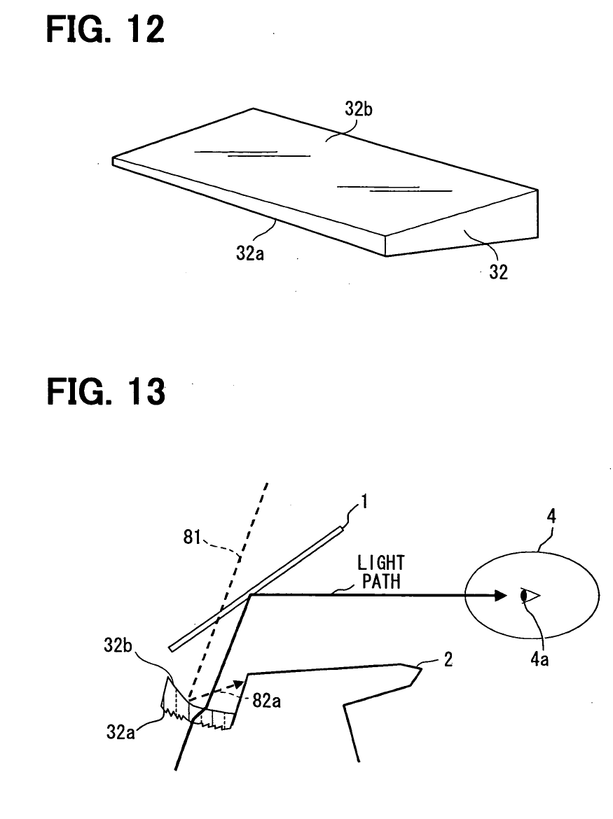

Yet another modification of the second embodiment may have the optical component with its incident side surface and the output side surface 32b in a twisted arrangement with each other as shown in FIG. 12.

Still yet another modification of the second embodiment may have the optical component that has the incident side surface 32a with the Fresnel pattern formed on a plane surface and the output side surface formed on a curved surface as shown in FIG. 13. The curved surface may have a free-form surface shown in FIG. 4 or a cylindrical surface having curvature in one direction. In this manner, the reflected light 82a on the output side surface 32b is redirected. In the illustration in FIG. 13, the reflected light 82a is obstructed by the instrument panel 1. Further, the incident side surface 32a may be perpendicular or may be tilted relative to the light axis of the expanded image 31a. The incident side surface 32a being perpendicular to the light axis of the expanded image 31a minimizes the distortion of the expanded image 31a in the course of the permeation of the optical component, and the incident side surface 32a being tilted relative to the light axis of the expanded image 31a directs the reflected light 82b on the reverse side of the incident side surface 32a toward a different direction of the virtual presentation image 5.

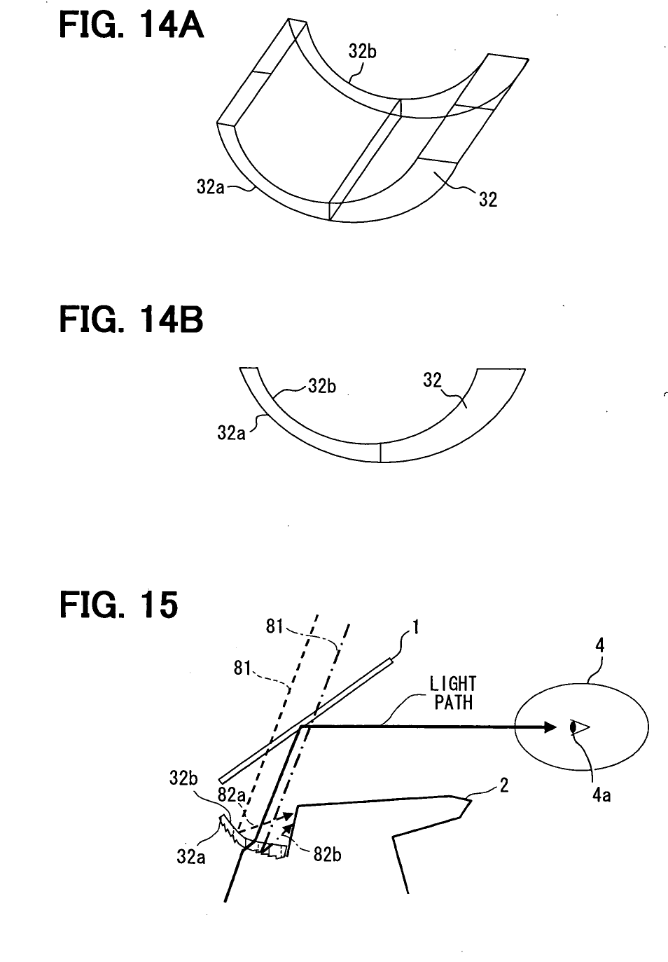

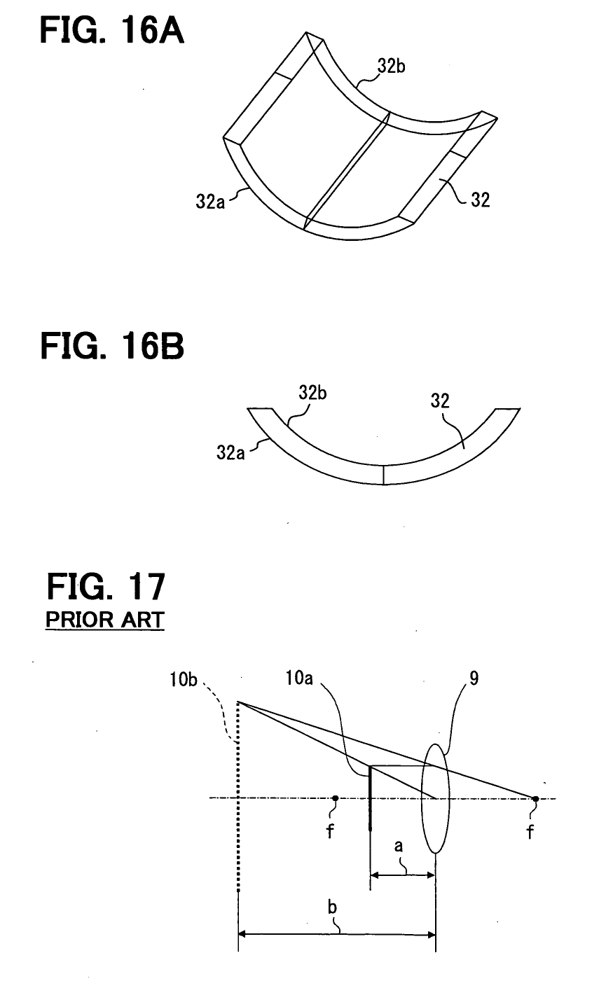

Still yet another modification of the second embodiment may have the optical component with both of the incident side surface 32a and the output side surface 32b formed as curved surfaces of non-equidistant relationship with each other as shown in FIGS. 14A and 14B. The illustration in FIG. 15 shows that the reflected light 82b on the reverse side of the incident side surface 32a and the reflected light 82a from the external light source on the output side surface 32b are obstructed by the instrument panel 1. The illustrations in FIGS. 16A and 16B show that the optical component with both of the incident side surface 32a and the output side surface 32b formed as curved surfaces of equidistant relationship with each other. In this case, both of the incident side surface 32a and the output side surface 32b may be formed as free-form surfaces as shown in FIG. 4.

Although the present invention has been fully described in connection with the preferred embodiment thereof with reference to the accompanying drawings, it is to be noted that various changes and modifications will become apparent to those skilled in the art.

For example, the hemispherical Fresnel lens 71 in the modification of the first embodiment may be used in the modifications of the second embodiment.

The Fresnel lens 32 for magnifying the reflected image 31a may be replaced with a different optical component that suitably magnifies the reflected image 31a. For example, the optical component such as a cylindrical concave lens or the like may be used in combination with the free-form mirror 33 that compensates the distortion caused by the concave lens or the like.

Such changes and modifications are to be understood as being within the scope of the present invention as defined by the appended claims.

What is claimed is:

1. A display apparatus for use in a vehicle comprising:
an irradiation source for irradiating a light of an image;
a redirection component for redirecting the light of the image;
an optical component for permeably magnifying the image in a course of permeation therethrough when the light of the image redirected by the redirection component enters therein; and
a reflection component for permeably reflecting the light of the image for visual perception of the light of the image as a virtual image by an occupant of the vehicle when the light of the image magnified by the optical component enters therein,
wherein the redirection component is disposed at an angle to a light axis of the light of the image irradiated by the irradiation source in a light path between the irradiation source and the optical component, and
the redirection component corrects a distortion of the virtual image in the visual perception by the occupant of the vehicle by at least one of the optical component and the reflection component.

2. The display apparatus as in claim 1,
wherein the redirection component lacks an axis of rotational symmetry at a point where the light axis of the light of the image irradiated by the irradiation source crosses the redirection component.

3. The display apparatus as in claim 1,
wherein the redirection component corrects the distortion of the image caused by the optical component in the course of the permeation therethrough when the image redirected by the redirection component enters the optical component.

4. The display apparatus as in claim 1,
wherein the redirection component corrects the distortion of the image caused by the reflection component in a course of at least one of permeation therethrough and reflection thereby when the image is redirected by the redirection component after magnification by the optical component.

5. The display apparatus as in claim 1,
wherein an incident side surface of the optical component is disposed perpendicularly to the light axis of the image redirected by the redirection component.

6. The display apparatus as in claim 1,
wherein an incident side surface of the optical component is disposed at a predetermined angle to the light axis of the image redirected by the optical component, and
the predetermined angle is defined as an angle that allows a redirection of an ambient light toward an outside of a view of the occupant of the vehicle when the ambient light is reflected by the incident side surface after entering from an output side surface on an opposite side relative to the incident side surface in the optical component.

7. The display apparatus as in claim 1,
wherein an output side surface of the optical component is disposed perpendicularly to the light axis of the image redirected by the optical component.

8. The display apparatus as in claim 5,
wherein an output side surface of the optical component is disposed perpendicularly to the light axis of the image redirected by the optical component.

9. The display apparatus as in claim 6,
wherein an output side surface of the optical component is disposed perpendicularly to the light axis of the image redirected by the optical component.

10. The display apparatus as in claim 1,
wherein an output side surface of the optical component is disposed at a predetermined angle to the light axis of the image redirected by the optical component, and
the predetermined angle is defined as an angle that allows a redirection of an ambient light toward an outside of a view of the occupant of the vehicle when the ambient light is reflected by the output side surface after entering from the output side surface on an opposite side relative to the incident side surface in the optical component.

11. The display apparatus as in claim 5,
wherein an output side surface of the optical component is disposed at a predetermined angle to the light axis of the image redirected by the optical component, and
the predetermined angle is defined as an angle that allows a redirection of an ambient light toward an outside of a view of the occupant of the vehicle when the ambient light is reflected by the output side surface after entering from the output side surface on an opposite side relative to the incident side surface in the optical component.

12. The display apparatus as in claim 6,
wherein an output side surface of the optical component is disposed at a predetermined angle to the light axis of the image redirected by the optical component, and
the predetermined angle is defined as an angle that allows a redirection of an ambient light toward an outside of a view of the occupant of the vehicle when the ambient light is reflected by the output side surface after entering from the output side surface on an opposite side relative to the incident side surface in the optical component.

13. The display apparatus as in claim 1,
wherein the image irradiated by the irradiation source is magnified by the optical component and the redirection component, and
a magnification rate of the image by the optical component is greater than the magnification rate of the image by the redirection component.

14. The display apparatus as in claim 1,
wherein the optical component is Fresnel lens.

15. The display apparatus as in claim 1,
wherein the Fresnel lens has an axis of rotation symmetry.

16. The display apparatus as in claim 1,
wherein the Fresnel lens is a cylindrical Fresnel lens,
the cylindrical Fresnel lens has a magnification rate in a first direction that is defined by a curvature of the reflection component in a second direction, and
the magnification rate of the Fresnel lens in a third direction that is perpendicular to the first direction is defined by the curvature of the reflection component in a fourth direction that is perpendicular to the second direction.

17. The display apparatus as in claim 14,
wherein the Fresnel lens is formed on a transparent plane board.

18. The display apparatus as in claim 14,
wherein the Fresnel lens has at least one of an incident side surface and an output side surface formed on a transparent curved board.

19. The display apparatus as in claim 1,
wherein an incident side surface of the optical component that receives an incident light of the image reflected by the redirection component and an output side surface of the optical component that outputs the light of the image that is redirected by the redirection component are disposed in a twisted position relative to each other.

20. The display apparatus as in claim 1,
wherein the light of the image irradiated by the irradiation source is redirected by at least one reflector including the redirection component beside being magnified by the optical component.

21. The display apparatus as in claim 1,
wherein a plurality of light axes of the light of the image irradiated by the irradiation source exist on a same plane in a light path between irradiation by the irradiation source and entrance to the optical component.

22. The display apparatus as in claim 20,
wherein a plurality of light axes of the light of the image irradiated by the irradiation source exist on a same plane in a light path between irradiation by the irradiation source and entrance to the optical component.

23. The display apparatus as in claim 1,
wherein the optical component is made of plural materials with respectively different refractive indexes.

24. The display apparatus as in claim 1,
wherein the redirection component is selectively replaceable according to a reflection characteristic of the reflection component.

25. The display apparatus as in claim 1,
wherein the virtual image has a relationship of similarity with the image irradiated by the irradiation source.
